(19) United States
(12) Patent Application Publication
(10) Pub. No.: US 2015/0111094 A1
(43) Pub. Date: Apr. 23, 2015

(54) STORAGE BATTERY

(71) Applicant: TOYODA GOSEI CO., LTD., Kiyosu-shi (JP)

(72) Inventors: Junta KATAYAMA, Toyota-shi (JP); Kenji KIMURA, Toyota-shi (JP); Yasunori UCHIDA, Kiyosu-shi (JP); Takaaki YOKOI, Kiyosu-shi (JP); Yoshiaki TATSUMI, Kiyosu-shi (JP)

(21) Appl. No.: 14/516,991

(22) Filed: Oct. 17, 2014

(30) Foreign Application Priority Data
Oct. 22, 2013 (JP) 2013-219329

(51) Int. Cl. H01M 2/06; H01M 2/30

(52) U.S. Cl. CPC H01M 2/06; H01M 2/30
USPC 429/179

(57) ABSTRACT

A storage battery includes a power storage element, a battery case, an internal insulating member, a second electrode terminal, an external insulating member. The power storage element has a stacked structure of a positive plate, a negative plate, and a separator. The battery case includes a first case and a second case that create a space to house the power storage element. The battery case is electrically connected with one electrode of the power storage element and includes a first electrode terminal. The internal insulating member is disposed in the space. The second electrode terminal is connected with the other electrode via the internal insulating member and disposed on a periphery of the battery case at a position different from the connecting part. The external insulating member insulates the second electrode terminal from the battery case.

### CROSS-REFERENCE TO RELATED APPLICATIONS

This application claims the benefit of Japanese Patent Application No. 2013-219329 (filed on Oct. 22, 2013), the entire contents of which are incorporated by reference herein.

### BACKGROUND

1. Technical Field

The present invention relates to a storage battery including a battery case housing a power storage element including a positive electrode body and a negative electrode body that are stacked via a separator.

2. Related Art

For example, the battery described in Patent Literature 1 is made by caulking a metallic positive electrode case and a metallic negative electrode case while sandwiching a resin gasket therebetween and encapsulating a power generation element therein. This type of battery has the merit of the reduced number of constituent members because the battery cases function also as positive and negative electrodes.

PTL 1: JP-A-2000-164259

However, for a need of simultaneously ensuring both insulation property between the electrodes and sealing property of the power generation element (sealing of the positive and negative electrode cases) at the caulked part (the part where the positive and negative electrode cases are caulked while sandwiching the gasket (insulating member) therebetween), the caulking processing comes to be difficult one.

More specifically, because the positive and negative electrodes are adjacent to each other via the gasket at the caulked site, the distance between the electrodes (insulating distance) becomes small. Thus, it is more likely that the gasket might be displaced during the caulking processing step, and the insulating distance might become smaller when the cases are highly deformed by the caulking processing. In addition, if the gasket cannot follow the deformation of the cases in the caulking processing where the metallic cases and the gasket are deformed together, clearance or the like could be created, which could not ensure sufficient sealing properties.

As described above, for the need of simultaneously ensuring insulation property between the electrodes at the part which is the same as the connecting part where the positive and negative electrode cases that constitute the battery case are sealed, the caulking processing comes to be difficult one.

In order to solve these problems, the object of the present invention is to provide a storage battery that can be configured by being subjected to easy processing with ensuring insulation properties and sealing properties simultaneously by performing separately connection of the cases that seal a storage element therein and extraction of positive and negative electrodes of the storage element.

### SUMMARY

(1) According to an aspect of the invention, a storage battery includes a power storage element that has a stacked structure of a positive plate, a negative plate, and a separator, a battery case that includes a first case and a second case that are made from metal, create a space to house the power storage element, and are welded to each other at a connecting part around the space, is electrically connected with one electrode of the power storage element, and includes a first electrode terminal, an internal insulating member that is disposed in the space and arranged to insulate the other electrode of the power storage element from the battery case having a potential of the one electrode;

a second electrode terminal that is connected with the other electrode via the internal insulating member and disposed on a periphery of the battery case at a position different from the connecting part, and an external insulating member that is arranged to insulate the second electrode terminal from the battery case.

According to the present invention, for the sake of the entire battery case having a unique electric potential of one of the electrodes (an electric potential of a single electrode) of the power storage element, the first case and the second case can be easily connected with each other by welding or the like without being insulated from each other. In addition, the other electrode can be extracted out of the battery case having the potential of the one electrode via the internal insulating member and the external insulating member at the part different from the connecting part between the first case and the second case.

Therefore, the storage battery has the configuration (1) that connection between the first case and the second case that seal the storage element therein is separated from extraction of positive and negative electrodes of the storage element, so that it is unnecessary to encapsulate the storage element therein while insulating the cases from each other. Thus, it is possible to provide a storage battery that can be configured by being subjected to easy processing while insulation properties and sealing properties can be ensured.

(2) In the storage battery of (1), the first case comprises an opening through which a connecting member connected with the other electrode and the second electrode terminal is arranged to pass from a position different from the connecting part to the outside of the case via the internal insulating member, and the second electrode terminal is provided at a position corresponding to the opening on the periphery of the first case via the external insulating member.

Because the storage battery has this configuration (2), only required is to provide the insulating structure corresponding to the second electrode terminal to the first case that is one of the constituent members of the battery case, which can reduce the number of constituent members.

(3) In the storage battery of (1) or (2), the first case further includes the first electrode terminal that includes an extended part of the connecting part and the connecting part being of a monolithic construction; and a contact portion that includes a deformed portion of an area of the first case that creates the space to house the power storage element, and is arranged to sandwich a portion of the power storage element with the second case to be in contact with the one electrode of the power storage element.

Because the storage battery has this configuration (3), the structure to extract the electrode of the power storage element that corresponds to the first electrode terminal can be simplified, which can reduce the number of constituent members.

(4) The storage battery of anyone of (1) to (3), the first electrode terminal is disposed depending on a position where the second electrode terminal is disposed, the power storage element includes a first power collecting portion corresponding to the one electrode and a second power collecting portion corresponding to the other electrode, the first power collecting portion and the second power collecting portion sandwiching an area where the positive plate, the negative plate, and the separator are stacked, both of the first electrode terminal and the second electrode terminal are disposed on one end side of the battery case where the second power collecting portion is disposed in a direction where the first power collecting portion and the second power collecting portion are aligned, and the first electrode terminal and the second electrode terminal are adjacent to each other via the external insulating member.

Because the storage battery has this configuration (4), the first electrode terminal and the second electrode terminal can be collectively disposed on the one end side of the battery case, which can improve the efficiency of space factor on a mounting surface of the battery case on which the electrode terminals are mounted. In addition, because the first electrode terminal and the second electrode terminal that are collectively disposed on the one end side are in contact with each other via the external insulating member arranged to insulate the battery case from the second electrode terminal, the electrode terminals can be insulated appropriately from each other while the number of constituent members can be reduced.

### BRIEF DESCRIPTION OF THE DRAWINGS

FIG. 1 is an exploded perspective view of the configuration of a unit cell in Example 1;

FIG. 2 is a view of the configuration of a power generation element to be housed in a battery case in embodiment 1;

FIG. 3 is a cross-sectional view of the unit cell on the X-Z plane at the position of an electrode terminal disposed on the periphery of the battery case via an internal insulating member and an external insulating member in embodiment 1;

FIG. 4 is an external perspective view of a unit cell in embodiment 1;

FIG. 5 is a cross-sectional view of the unit cell on the X-Y plane, and is a view for illustrating a connecting structure between the power generation element and the battery case in embodiment 1; and

FIG. 6 is a view of an assembled battery including a plurality of stacked unit cells in embodiment 1.

### DETAILED DESCRIPTION

Hereinafter, a description of an embodiment according to the present invention will be provided.

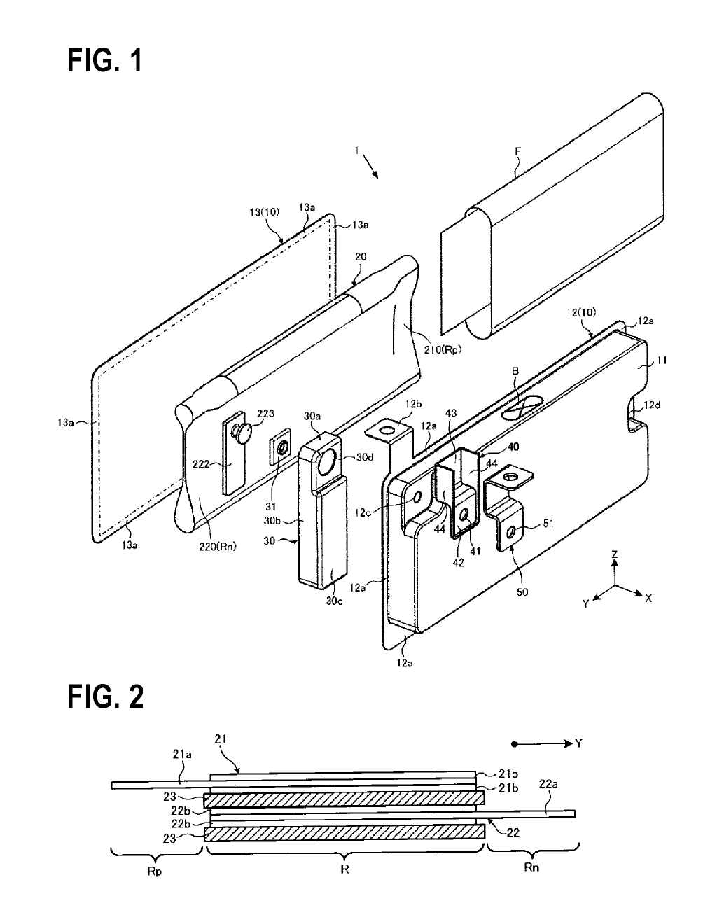

FIGS. 1 to 6 are views for illustrating the embodiment according to the present invention. FIG. 1 is an exploded perspective view of the configuration of a unit cell. The X-axis, the Y-axis, and the Z-axis define axes that are perpendicular to one another in FIG. 1 and the like. The relation among the X-axis, the Y-axis, and the Z-axis is same in other drawings. The axis corresponding to the vertical direction is defined as the Z-axis in the present embodiment.

A unit cell (corresponding to a storage battery) 1 according to the present embodiment can be used in an assembled battery that are made of the plurality of unit cells 1 connected in series, and can be used mainly as a secondary battery installed in a hybrid car, an electric car, or the like. Examples of the unit cell 1 include a nickel-hydrogen battery, a lithium-ion secondary battery, and a nickel-cadmium battery.

The unit cell 1 according to the present embodiment includes a battery case 10 and a power generation element (corresponding to a power storage element) 20 arranged to be stored in the battery case 10 as shown in FIG. 1. The battery case 10 includes a first case 12 including a concave portion 11 that forms a housing space arranged to house the power generation element 20, and a second case 13 that covers the opening of the concave portion 11. The first case 12 and the second case 13 can be made from a conductive metallic material.

The first case 12 can be formed, for example, by subjecting a metallic plate to press working so as to be dented in the X-direction from the Y-Z plane. At this time, a flange portion 12a extending from the periphery of the opening edge of the concave portion 11 can be provided to the periphery of the opening plane of the concave portion 11, that is, around the housing space for the power generation element 20.

A level difference is made in the X-direction by a bottom portion 11a of the concave portion 11 and the flange portion 12a. The wall portions of the concave portion 11 form the upper surface and the lower surface in the Z-direction, the lateral surfaces in the Y-direction, and the lateral surface in the X-direction of the unit cell 1. Thus, the unit cell 1 has the shape of a low-profiled rectangular battery as a whole. It is to be noted that the unit cell 1 may have the outer shape of a flattened round battery, for example, by forming the wall portions of the concave portion 11 in a circle.

The second case 13 defines a case member paired with the first case 12, and defines a plate-shaped member arranged to close the opening of the concave portion 11. The second case 13 includes an edge portion 13a corresponding to the flange portion 12a of the first case 12 (the area indicated with the alternate long and short dash line). The flange portion 12a and the edge portion 13a that constitute a connecting part of the battery case 10 are brought into contact with each other and welded on the Y-Z plane. Welding the first case 12 and the second case 13 at the connecting part allows the power generation element 20 to be encapsulated in the battery case 10.

FIG. 2 is a view of one example of a stack electrode sheet that constitutes the power generation element 20 according to the present embodiment. The power generation element 20 includes a positive plate 21, a negative plate 22, and separators 23. The positive plate 21 includes a current collecting foil 21a, and cathode active material layers 21b formed on the surfaces of the current collecting foil 21a. The cathode active material layers 21b contain a cathode active material, an electrical conducting material, a binder, and the like. The cathode active material layers 21b are disposed on partial areas of the current collecting foil 21a. That is, the current collecting foil 21a includes an extended area where the cathode active material layers 21b are not provided, the extended area being outside of an area where the current collecting foil 21a faces the separator 23 and the cathode active material layers 21b are disposed.

The negative plate 22 includes a current collecting foil 22a, and anode active material layers 22b formed on the surfaces of the current collecting foil 22a. The anode active material layers 22b contain an anode active material, an electrical conducting material, a binder, and the like. The anode active material layers 22b are disposed on partial areas of the current collecting foil 22a. That is, the current collecting foil 22a includes an extended area where the anode active material layers 22b are not provided, the extended area being outside of an area where the current collecting foil 22a faces the separator 23 and the anode active material layers 22b are disposed. The cathode active material layers 21b, the anode active material layers 22b, and the separators 23 are impregnated with an electrolyte solution.

Each of the positive plate 21, the negative plate 22, and the separators 23 can be strip-shaped. The positive plate 21, the separator 23, the negative plate 22, and the separator 23 can be stacked in this order such as shown in FIG. 2. For example, the stack electrode sheet is rolled up taking the Y-direction as the axis of rotation such that the positive plate 21 becomes inside, and thereby the power generation element 20 having a configuration of being rolled up into a scroll pattern can be obtained. At this time, the separator 23 is disposed on the outermost surface in the rolled direction, so that a plurality of power generation areas R where the positive plate 21 faces the negative plate 22 via the separators 23 are formed in the rolled-up body in the scroll pattern. Chemical reactions occur in the power generation areas R at the time of charged and discharge of the unit cell 1.

A description will be provided taking a lithium-ion battery as one example. At the time of discharge of the lithium-ion battery, a chemical reaction of emitting lithium ions and electrons occurs on an interface of the anode active material while a chemical reaction of absorbing lithium ions and electrons occurs on an interface of the cathode active material. At the time of charge of the lithium-ion battery, a reaction opposite to the reaction at the time of discharge occurs. The charge and discharge of the lithium-ion battery is performed by giving and receiving the lithium ions via the positive plate 21, the negative plate 22, and the separators 23.

An area Rp where only the plurality of current collecting foils 21a are rolled up is formed on one end in the Y-direction and an area Rn where only the plurality of current collecting foils 22a are rolled up is formed on the other end while sandwiching the power generation areas R between the area Rp and the area Rn in the power generation element 20 of the rolled-up body. The area Rp and the area Rn respectively define the positive electrode and the negative electrode of the power generation element 20. The area Rp defines a power collecting portion 210 of the plurality of current collecting foils 21a. Likewise, the area Rn defines a power collecting portion 220 of the plurality of current collecting foils 22a. It is to be noted that the entire power generation element 20 can be covered with an insulating film F (see FIG. 1).

In the present embodiment, the power generation element 20 is housed in the battery case 10 to configure the rectangular unit cell 1 having its longitudinal direction in the Y-direction. In addition, the battery case 10 functions also as one electrode of the power generation element 20, and an electrode terminal 50 (corresponding to the second electrode terminal) that is connected with the other electrode of the power generation element 20 while being insulated from the battery case 10 is provided.

To be specific, the battery case 10 creates a space to house the power generation element 20, includes the metallic first case 12 and the metallic second case 13 that are welded to each other at the connecting part around the housing space, is electrically connected with the one electrode of the power generation element 20, and includes an electrode terminal 12b (corresponding to the first electrode terminal).

The electrode terminal 12b and the first case 12 can be of a monolithic construction by extending a part of the flange portion 12a that constitutes the connecting part of the first case 12. In the present embodiment, the battery case 10 (first case 12) constituting the unit cell 1 has the potential of the one electrode of the power generation element 20, and the case itself constitutes an electrode. Thus, the electrode terminal 12b can be formed by extending a part of the first case 12 upward in the Z-direction. The electrode terminal 12b is disposed at a position different from the flange portion 12a on the Y-Z plane. It is to be noted that the electrode terminal 12b may have a configuration separate from the first case 12.

In addition, the unit cell 1 includes an internal insulating member 30 that is disposed in the housing space and arranged to insulate the other electrode of the power generation element 20 from the battery case 10 having the potential of the one electrode of the power generation element 20, the electrode terminal 50 that is connected with the other electrode of the power generation element 20 via the internal insulating member 30 and disposed on the periphery of the battery case 10 at a position different from the connecting part of the battery case 10, and an external insulating member 40 arranged to insulate the electrode terminal 50 from the battery case 10.

The unit cell 1 according to the present embodiment having the configuration described above that the battery case 10 itself functions also as one electrode of the unit cell 1, and the entire battery case 10 has the potential of the one (single electrode) of the positive and negative electrodes of the unit cell 1. Thus, the other electrode of the power generation element 20 can be extracted out of the battery case 10 having the potential of the one electrode by the insulating structure including the internal insulating member 30 and the external insulating member 40.

Hereinafter, descriptions will be provided taking the electrode terminal 12b corresponding to the first electrode terminal as the positive electrode terminal of the unit cell 1 while taking the electrode terminal 50 corresponding to the second electrode terminal as the negative electrode terminal of the unit cell 1. It is to be noted that the positive and negative electrodes may be opposite.

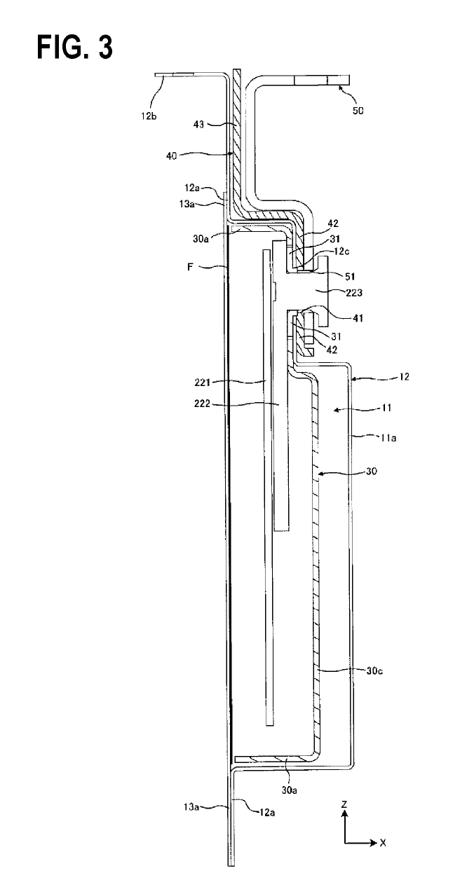

FIG. 3 is a cross-sectional view of the unit cell 1 on the X-Z plane at the position where the electrode terminal 50 is disposed. A current collector 211 connected with the plurality of current collecting foils 22a is provided in the area Rn that constitutes the power collecting portion 220 of the plurality of current collecting foils 22a as shown in FIGS. 1 and 3. A current collecting terminal 222 defines a connecting member electrically connected with the current collector 221. The current collecting terminal 222 is disposed on the side facing the first case 12 in the X-direction. The area of the power collecting portion 220 except the current collecting terminal 222 is covered with the insulating film F.

The internal insulating member 30 disposed in the housing space of the power generation element 20 is disposed between the current collecting terminal 222 and the first case 12. The internal insulating member 30 is arranged to insulate the current collecting terminal 222 from the first case 12 having the positive electrode potential. To be specific, the internal insulating member 30 has an outer shape larger than the current collecting terminal 222, and includes wall portions 30a and 30b that cover the periphery of the current collecting terminal 222, and a wall portion 30a that is opposed to the current collecting terminal 222 in the X-direction and is approximately parallel to the first case 12 on the Y-Z plane as shown in FIG. 1.

The current collecting terminal 222 defines a connecting member arranged to extract the negative electrode of the power generation element 20 out of the battery case 10, so that a connecting portion 223 extending in the X-direction from the current collecting terminal 222 is provided to the current collecting terminal 222. The connecting portion 223 has a length such that the end portion of the connecting portion 223 is exposed to the outside of the first case 12 via the internal insulating member 30. The wall portion 30c of the internal insulating member 30 includes an opening 30d corresponding to the connecting portion 223 of the current collecting terminal 222. The opening 30d has a size such that the connecting portion 223 can pass through the opening 30d.

In addition, the first case 12 includes an opening 12c corresponding to the opening 30d. The opening 12c defines an opening through which the connecting portion 223 connected with the negative electrode of the power generation element 20 and the electrode terminal 50 is arranged to pass from a position different from the connecting part of the battery case 10 to the outside of the case via the internal insulating member 30.

It is to be noted that the internal insulating member 30 may include a gasket 31 arranged to insulate the connecting portion 223 from the opening 12c of the first case 12. The gasket 31 includes a wall portion having a tubular hollow interior and extending toward the opening 12c of the first case 12 from the opening 30d of the internal insulating member 30. The connecting portion 223 passes through the tubular interior of the wall portion, so that the gasket 31 can insulate the connecting portion 223 from the first case 12. The gasket 31 and the internal insulating member 30 may be of a monolithic construction.

The electrode terminal 50 is disposed at a position corresponding to the opening 12c of the first case 12 on the periphery (the outer surface) of the first case 12 via the external insulating member 40. In the external insulating member 40, one surface is in contact with the first case 12 while the other surface is in contact with the electrode terminal 50 in the X-direction. The external insulating member 40 and the electrode terminal 50 respectively include an opening 41 and an opening 51 that correspond to the opening 12c of the first case 12. The opening 12c, the opening 41, and the opening 51 are disposed at the same position where the connecting portion 223 protrudes in the X-direction.

It is to be noted that a part of the unit cell 1 close to the upper surface in the Z-direction where the electrode terminal 12b and the electrode terminal 50 are disposed is dented in the X-direction that is the opposite direction to the concave direction of the concave portion 11 in the example of FIG. 3 and the like. The electrode terminal 12b and the electrode terminal 50 are formed in accordance with the level difference formed by the dent.

The external insulating member 40 according to the present embodiment includes a first insulating portion 42 disposed between the first case 12 having the positive electrode potential and the electrode terminal 50 to insulate them and including the opening 41 through which the connecting portion 223 passes, a second insulating portion 43 extending upward in the Z-direction from the first insulating portion 42 to insulate the electrode terminal 12b from the electrode terminal 50, the electrode terminal 12b and the electrode terminal 50 being adjacent to each other in the X-direction, and a third insulating portion 44 extending in the X-direction from both ends in the Y-direction of the first insulating portion 42 and the second insulating portion 43 as shown in FIG. 3. The third insulating portion 44 has a configuration of a wall portion extending in the X-direction, so that a large insulating distance in the Y-direction between the electrode terminal 50, and the first case 12 and the electrode terminal 12b can be ensured. It is to be noted that the internal insulating member 30 and the external insulating member 40 can be made from an insulating material such as resin.

The connecting portion 223 and the electrode terminal 50 can be fastened by being subjected to caulking processing. For example, by forming a caulking portion (an umbrella portion) at the end portion in the X-direction of the connecting portion 223 to caulk the opening 51 in the X-direction with the caulking portion that has passed through the opening 12c, the opening 41, and the opening 51, the connecting portion 223, and the electrode terminal 50 can be electrically connected with one another while the external insulating member 40 and the electrode terminal 50 are fastened to the first case 12. At this time, the electrode terminal 50 and the connecting portion 223 (the caulking portion) can be fastened by welding.

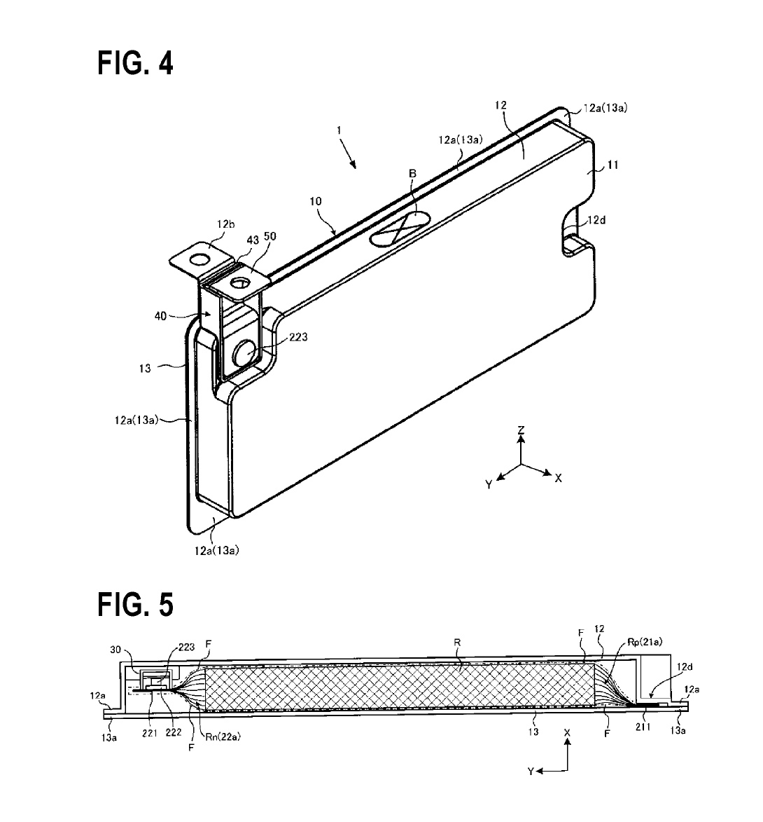

FIG. 4 is an external perspective view of the unit cell 1. The external insulating member 40 is disposed in an area where the electrode terminal 12b provided to the first case 12 and the opening 12c on the lateral surface in the X-direction of the first case 12 (the flat bottom portion of the concave portion 11) are provided as shown in FIG. 4. The electrode terminal 50 is disposed on the periphery of the battery case 10 while being insulated from the first case 12 and the electrode terminal 12b by the external insulating member 40.

In addition, the electrode terminal 12b constituting the positive electrode terminal of the unit cell 1 is disposed at the position at the end portion in the Y-direction where the electrode terminal 50 is disposed so as to be adjacent to the electrode terminal 50 in the X-direction via the external insulating member 40 as shown in FIG. 4.

Because the unit cell 1 has the configuration described above, the electrode terminal 12b and the electrode terminal 50 can be collectively disposed on one end side in the Y-direction (the one end side of the battery case 10 where the power collecting portion 220 is disposed in a direction where the power collecting portion 210 of the area Rp and the power collecting portion 220 of the area Rn are aligned sandwiching the power generation areas R) on the upper surface in the Z-direction of the battery case 10 where the electrode terminal 12b and the electrode terminal 50 are provided. Thus, the efficiency of space factor on the upper surface (mounting surface) in the Z-direction of the battery case 10 on which the electrode terminal 12b and the electrode terminal 50 are mounted can be improved.

In addition, the electrode terminal 12b and the electrode terminal 50 collectively disposed on the one end side are brought into contact with each other via the external insulating member 40 insulating the battery case 10 and the electrode terminal 50, so that the electrode terminals can be insulated appropriately from each other while the number of constituent members can be reduced.

FIG. 5 is a view for illustrating an electrically connecting structure of the power generation element 20 housed in the battery case 10. A current collector 211 connected with the plurality of current collecting foils 21a (the area Rp) and the current collector 221 connected with the plurality of current collecting foils 22a (the area Rn) are disposed at both ends in the Y-direction of the power generation element 20 while sandwiching the power generation areas R (the hatched area) as shown in FIG. 5.

In the present embodiment, a contact portion 12d that is a deformed concave portion of the first case 12 creating the space to house the power generation element 20 and is arranged to sandwich the current collector 211 of the power generation element 20 between the first case 12 and the second case 13 to be in contact with the one electrode (positive electrode) of the power generation element 20 is provided at a position corresponding to the current collector 211 of the power generation element 20 housed in the battery case 10.

The contact portion 12d is provided in the area where the current collector 211 is disposed on the other end side that is opposite to the one end side in the Y-direction where the electrode terminal 12b and the electrode terminal 50 are disposed, and thereby the current collector 211 is electrically connected with both of the first case 12 and the second case 13. The entire battery case 10 is made to have the potential of the one electrode of the power generation element 20 via the contact portion 12d. It is to be noted that because the first case 12 and the second case 13 are welded to each other, the contact portion 12d may have a configuration of being electrically connected with either one of the first case 12 and the second case 13.

In addition, sandwiching the current collector 211 of the power generation element 20 between the first case 12 and the second case 13, the contact portion 12d according to the present embodiment can function also as a fastening portion arranged to fasten the power generation element 20 to the battery case 10. Because the current collector 211 is fastened to the first case 12 via the current collecting terminal 222 and the connecting portion 223 as described above, the power generation element 20 can be fastened and disposed in the battery case 10.

It is to be noted that the alternate long and short dash line indicates the insulating film F in the example of FIG. 5. Thus, the insulating film F covers the periphery of the power generation element 20 except the areas corresponding to the internal insulating member 30 (or the current collecting terminal 222) and the contact portion 12d.

Because in the unit cell 1 according to the present embodiment, the entire battery case 10 has the electric potential of one of the electrodes (electric potential of a single electrode) of the power generation element 20, the first case 12 and the second case 13 can be easily connected with each other by welding or the like without being insulated from each other. In addition, the other electrode can be extracted out of the battery case 10 having the potential of the one electrode via the internal insulating member 30 and the external insulating member 40 at the part different from the connecting part between the first case 12 and the second case 13.

Therefore, the configuration that the connection between the first case 12 and the second case 13 that seal the power generation element 20 therein is separated from the extraction of the positive and negative electrodes of the power generation element 20 is obtained, so that it is unnecessary to encapsulate the power generation element 20 therein while insulating the cases from each other. Thus, it is possible to provide a storage battery that can be configured by being subjected to easy processing while insulation properties and sealing properties are ensured.

In addition, the opening 12c through which the connecting portion 223 of the current collecting terminal 222 is arranged to pass from the position different from the connecting part to the outside of the case via the internal insulating member 30 is provided to the first case 12 of the battery case 10. The electrode terminal 50 is provided at the position corresponding to the opening 12c on the periphery of the first case 12 via the external insulating member 40. Thus, it is essential only to provide the insulating structure corresponding to the electrode terminal 50 only to the first case 12 that is one of the constituent members of the battery case 10, which can reduce the number of constituent members.

In addition, the first case 12 includes the electrode terminal 12b that is the extended part of the connecting part (the flange portion 12a), the electrode terminal 12b and the connecting part being of a monolithic construction, and the contact portion 12d that is the deformed portion of the first case 12 creating the space to house the power generation element 20. Thus, the structure to extract the electrode of the power generation element 20 that corresponds to the electrode terminal 12b can be simplified, which can reduce the number of constituent members. In particular, the electrode terminal 12b and the first case 12 can be of a monolithic construction by subjecting a metallic plate to press working, which can reduce the production cost of the battery case 10.

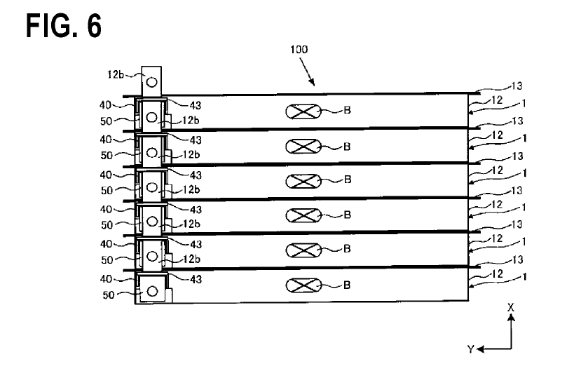

In addition, in the unit cell 1 according to the present embodiment, the electrode terminal 12b and the electrode terminal 50 are collectively disposed on the one end side in the Y-direction on the upper surface in the Z-direction of the battery case 10 on which the electrode terminal 12b and the electrode terminal 50 are provided. In this case, for example, if the plurality of unit cells 1 are stacked to constitute an assembled battery 100 as shown in FIG. 6, the efficiency of space on the upper surface in the Z-direction of the assembled battery 100 on which the electrode terminals 12b and the electrode terminals 50 are disposed can be improved. By improving the efficiency of space on the upper surface of the assembled battery 100 on which the electrode terminals 12b and the electrode terminals 50 are disposed, the empty space can be used as an exhaust gas path, a wiring space for a sensor apparatus or power lines, or the like of the unit cells 1. It is to be noted that the sections indicated with the signs B are exhaust valves for emitting gas to the outside of the battery cases 10 when gas is generated inside the battery cases 10.

In addition, because the electrode terminals 12b and the electrode terminals 50 are collectively disposed on the one end side in the Y-direction, the electrode terminals 12b and the electrode terminals 50 of the unit cells 1 are aligned in the lamination direction. Thus, connecting the electrode terminal 12b of one of the unit cells 1 adjacent to each other in the lamination direction with the electrode terminal 50 of the other unit cell 1 allows the unit cells 1 to be connected with each other in series. Thus, connection between the electrode terminals, mounting of bus bars, and the like can be easily performed.

Further, the first case 12 of one of the unit cells 1 adjacent to each other and the second case 13 of the other unit cell 1 have a potential of the same single electrodes, so that it is unnecessary to insulate the battery cases 10 of the unit cells 1 from each other that are adjacent to each other in the X-direction, which can reduce the number of constituent members. In addition, the stacked unit cells 1 have a potential of the same single electrodes, which can retard corrosion that could occur if the first case 12 of one of the unit cells 1 adjacent to each other and the second case 13 of the other unit cell 1 had different electrodes. It is to be noted that partition members made from a resin material may be provided between the stacked unit cells 1.

It is to be noted that the flange portions 12a of the first cases 12 and the dge portions 13a of the second cases 13 can be made also as cooling fins of the unit cells 1. In this case, bringing the flange portions 12a and the dge portions 13a into contact with cooling wind allows the unit cells 1 (the assembled battery 100) to be cooled.

### DESCRIPTION OF REFERENCE NUMERALS AND SIGNS

1: Unit cell, 10: Battery case, 11: Concave portion, 12: First case, 12a: Flange portion, 12b: Electrode terminal (First electrode terminal), 12c: Opening, 12d: Contact portion, 13: Second case, 13a: Edge portion, 20: Power generation element, 21: Positive plate, 22: Negative plate, 23: Separator, 210, 220: Power collecting portion, 222: Current collecting terminal, 223: Connecting portion, 30: Internal insulating member, 40: External insulating member, 50: Electrode terminal (Second electrode terminal)

What is claimed is:

1. A storage battery comprising:
a power storage element that has a stacked structure of a positive plate, a negative plate, and a separator disposed between the positive plate and the negative plate;
a battery case that includes a first case and a second case that are made from metal, create a space to house the power storage element, and are welded to each other at a connecting part around the space, is electrically connected with one electrode of the power storage element, and includes a first electrode terminal;
an internal insulating member that is disposed in the space and arranged to insulate the other electrode of the power storage element from the battery case having a potential of the one electrode;
a second electrode terminal that is connected with the other electrode via the internal insulating member and disposed on a periphery of the battery case at a position different from the connecting part; and
an external insulating member that is arranged to insulate the second electrode terminal from the battery case.

2. The storage battery according to claim 1,
wherein the first case comprises an opening through which a connecting member connected with the other electrode and the second electrode terminal is arranged to pass from a position different from the connecting part to the outside of the case via the internal insulating member, and
wherein the second electrode terminal is provided at a position corresponding to the opening on the periphery of the first case via the external insulating member.

3. The storage battery according to claim 1,
wherein the first case further includes:
the first electrode terminal that includes an extended part of the connecting part and the connecting part being of a monolithic construction; and
a contact portion that includes a deformed portion of an area of the first case that creates the space to house the power storage element, and is arranged to sandwich a portion of the power storage element with the second case to be in contact with the one electrode of the power storage element.

4. The storage battery according to claim 1,
wherein the first electrode terminal is disposed depending on a position where the second electrode terminal is disposed,
wherein the power storage element includes a first power collecting portion corresponding to the one electrode and a second power collecting portion corresponding to the other electrode, the first power collecting portion and the second power collecting portion sandwiching an area where the positive plate, the negative plate, and the separator are stacked,
wherein both of the first electrode terminal and the second electrode terminal are disposed on one end side of the battery case where the second power collecting portion is disposed in a direction where the first power collecting portion and the second power collecting portion are aligned, and
wherein the first electrode terminal and the second electrode terminal are adjacent to each other via the external insulating member.
